(19) United States
(12) Patent Application Publication
(10) Pub. No.: US 2011/0156397 A1
(43) Pub. Date: Jun. 30, 2011

(54) UNDERWATER ELECTRICAL GENERATOR FOR THE HARNESSING OF BIDIRECTIONAL FLOOD CURRENTS

(75) Inventors: Amable LOPEZ PIÑEIRO, Madrid (ES); Luis Ramón Nuñez Rivas, Madrid (ES); José Andrés Somolinos Sanchez, Madrid (ES); Luis Perez Rojas, Madrid (ES); Ignacio Diez Ulzurrun Romeo, Madrid (ES); Francisco Perez Arribas, Madrid (ES); Eva Maria Novoa Rojas, Madrid (ES); Alfonso Manuel Carneros Lozano, Madrid (ES); Francisco Gerardo Del Castillo De Comas, Madrid (ES)

(73) Assignees: UNIVERSIDAD POLITÉCNICA DE MADRID, Madrid (ES); FUNDACION CENTRO TECHNOLOGICO SOERMAR, Madrid (ES)

(21) Appl. No.: 12/978,993

(22) Filed: Dec. 27, 2010

(30) Foreign Application Priority Data
Dec. 30, 2009 (ES) 200931297

(51) Int. Cl. F03B 13/10

(52) U.S. Cl. 290/54

(57) ABSTRACT

Underwater electrical energy generator with a three-blade propeller for the harnessing of energy from the water in the direction of its axis, in both directions. The propeller drives an alternating current generator located in a central dome from which there extend three arms joined to floats which close the Y-shaped structure by means of tie beams. The assembly has neutral floatability and is set into position by means of an anchoring system with a set of buoys joined to the bottom by one or more cables. An end of the generator is joined to an anchoring line by means of a horizontal cable in one of the main directions of the current. From the other end another two horizontal cables, open at an angle with respect to the direction of the current, are joined to another two anchoring lines. The assembly can be ballasted to go from an operating vertical underwater position to a horizontal floating position to facilitate maintenance tasks.

This application claims benefit of Serial No. 200931297, filed 30 Dec. 2009 in Spain and which application is incorporated herein by reference. To the extent appropriate, a claim of priority is made to the above disclosed application.

### TECHNICAL FIELD

The invention refers to the field of offshore technology and specifically to plants for the harnessing of renewable marine energy.

### STATE OF THE ART

Nowadays, there exists considerable interest in the harnessing of renewable marine energy. The harnessing of energy from currents (both of the inertial type, and the one produced by tides), is an example of the ones with highest potential.

The most widespread design consists of a structure fixed on the ocean floor, on which the generators (electrical ones) are mounted, generators which are driven by propellers with very slender blades, similar to those of wind generators.

Most part of the structure is underwater (including generators and propellers), with only a small part protruding from the ocean surface, which allows access to the inside of the plant and, eventually, the lifting of active elements for important maintenance tasks.

With this design, the depth of the operation area is limited, being appropriate only for pre-continental type of oceans such as the North Sea. This type of plants cannot be used with water sheets over 40 m.

In all anchored marine systems, one of the problems to be solved is the turning of the elements, when the currents have a hodogram (horizontal representation of the geometric place of the speed variation across time) of ellipsoidal type, which naturally, produce a “kinking” of the cables and a winding of ones with the others.

In April 2007 the Universidad Politécnica de Madrid (UPM, Technical University of Madrid) submitted before the Spanish Patent and Trade Mark Office (SPTO) the invention patent application P200700985, entitled “Submergible system for exploiting the energy of marine currents”, granted by SPTO resolution dated Jul. 27 2008, published in the BOPI (Industrial property gazette) on Jul. 16, 2008.

Based on this patent, the UPM and F.C.T. SOERMAR are working on the functional design of a generator called GESMEY, whose adaptation to ellipsoidal currents is the object of this new patent.

### DETAILED DESCRIPTION OF THE INVENTION

The object of the present invention is an underwater electrical energy generator, as it can be seen in FIG. 1, comprising a rotor or propeller with several blades, which drives an AC generator, located in a central dome (POD), from which there extend, radially or in a star shape, several arms or columns, located in a plane perpendicular to the rotor axis, existing at the end of each arm a float (torpedo), with its axis parallel to that of the rotor. The torpedoes are closed, by means of tie beams with a Y-shaped structure, so that there exist coupling points in the rotor axis in both directions.

All elements will have a hydrodynamic shape appropriate to reduce their viscous and pressure resistance, as they will be subjected to the speed of the current, so they will produce a dragging force which must be endured by the anchoring system.

The set of elements described constitute a generator, being possible to arrange a set thereof in one area, for the harnessing of energy, forming a “fleet of underwater generators” which can share the control unit and the energy transport system to the ground from a conversion unit.

Besides improving the stiffness of the set, this “in-cage structure” design enables that, aligning the axis with the main direction of the current, when it comes in one direction, the set can be supported with one or more cables connected at the tie beam union point.

When the current changes direction, the cables energized are the ones connected at the end of the dome where the arms are joined together. The joining of the cables at points which are in the extension of the rotor axis minimizes the moments when the generator tends to incline with respect to the direction of the current.

The set has hydrostatic equilibrium, so that the total weight is practically the same as the volume of water being shifted. In this way, only horizontal forces are generated, supported by the horizontal cables which are joined to their corresponding vertical anchorage lines.

The distribution of weights and pressure allows that during operation, the rotational torque and the moment of inclination hydrostatically compensate each other. To achieve that, there are arranged ballast tanks, which can be filled with water or emptied with air, located in the arms and in the torpedoes.

The distribution of weights and pressure can be modified, by a ballast system which is remote controlled by pumps, valves and blow air bottles, which are in turn remote controlled by means of an automatic control system and acoustic and/or cable links, so that in the operation position, in the torpedo and column of the lower arm the weight is greater than the pressure, and in the upper torpedo and columns the pressure is greater than the weight.

In this way, the centre of gravity of the set is under the centre of pressure, this “metacentric height” producing the necessary moments of stabilization for the generating unit to maintain the vertical position, shown in FIG. 1, which is the optimum one for the operation of the propeller, as the horizontal component prevails in marine currents.

By emptying the water from the ballast tanks it will be possible to grant a positive floatability to the set, so that releasing or loosening the anchoring system, it will surface and when changing the positions of the centres of gravity (by means of the ballasts) and the centres of pressure (at surfacing), the structure rotates and adopts the horizontal position, as it can be seen in the different phases of FIG. 5.

This procedure can be reversed for the start-up of the unit, going from the horizontal floating position to the vertical underwater working position.

These processes, the start-up and the setting into the floating position for maintenance, can be performed with a reduced current speed, and they will be coordinated with a remote controlled system of coupling and release of the generator with the anchoring system, complemented by a guiding cable between both parts, which reaches an auxiliary buoy in the surface.

The arrangement of the star-shaped arms, extending as radius from the central dome, enables that, when the set is floating to perform the maintenance tasks, access to the dome with craft is facilitated, and good stability is achieved. As the number of blades of the propeller equals that of columns, they can be stowed ones on top of the others, improving accessibility, self-protection of the most sensitive elements and facilitating the transfer, installation and maintenance tasks.

The anchoring system is based on several anchoring lines, each one of which has a buoy with a vertical cable up to a coupling point located at the work depth of the generator, from which there protrude one or several cables up to the bottom, where the line is fixed by means of anchor buoys, anchors, piles or other fixing systems. By providing the buoy with appropriate floatability, it is attained that a joining cable thereto is vertical and the displacement of the coupling point, due to the tension of the horizontal cables coming from the generator, is reduced.

FIG. 2 shows the base solution in which there is only one cable from the coupling point to the bottom and FIG. 3 shows a variant where the buoy is at work depth, incorporating therein the coupling point.

As regards the horizontal disposition of the anchoring, there can be as many horizontal cables as desired joined on one side, to the ends of the generator and on the other side to their corresponding coupling points in the anchoring lines.

FIGS. 2 and 4 show a combination with one cable from the end of the tie beams and two from that of the arms. With this arrangement, it is possible to reduce the “shadow effect” of the anchoring lines on the rotor, without complicating the surfacing manoeuvre, as it is enough to place and operate a slip hook in the line connected to the tie beams.

Also, this triangular arrangement, letting the horizontal lines form a slight catenary without current, limits the vertical and horizontal movements of the generator, automatically aligning the generator axis with that of the current.

This arrangement also allows, as it can be seen in FIG. 4, to use each vertical anchoring line for three generators, thus minimizing their number in a large field. On the other hand, a lateral displacement is attained between a line of generators and the adjacent ones, thus increasing, to the double the distance between buoys and the separation between generators, reducing the “shadow effect” of those which are over the water surface on top of the others.

### BRIEF DESCRIPTION OF THE DRAWINGS

FIG. 1 shows the basic design of the generator comprising the following elements:

(1) Propeller with several blades, which can be a fixed or controllable pitch propeller.
(2) Central dome where the electrical generator is housed, driven by the propeller.
(3) Arms of the structure, oval-shaped, to reduce the resistance to current. They serve as auxiliary ballast tanks.
(4) Floats of the ends, shaped like torpedoes, which house the main ballast tanks.
(5) Tie beams for the closure of the structure, also having an oval shape.

FIG. 2 shows a side plan view of a generator with its three anchoring lines. Each anchoring line comprises:

(6) Submerged or semi-submerged buoy.
(7) Fixing system to the bottom.
(8) Fastening cable.
(9) Coupling point.

From the joining point of the tie beams of the generator, a horizontal fastening cable (10) is set, which joins it to the anchoring line on the right. From the opposite end (joining of the arms with the dome) there extend two fastening cables (11) and (12) which are joined to the other two anchoring lines.

FIG. 3 shows a variant where the buoys are located at the same depth as the generator, joining the coupling point and the buoy.

FIG. 4 shows an aspect of a generator fleet, in which it can be seen how the anchoring lines are shared by close generators and how the arrangement of the buoys in staggered formation enables to increase the density of the generators in a fleet, maintaining a great distance between consecutive ones in the direction of the current.

FIG. 5 shows the process to refloat the generator, which consists of releasing (with a remote control system) the coupling between the cable (10) and its vertical anchoring line, and reducing, in a controlled manner, the amount of ballast water in the generator, so that a slight positive floatability is obtained.

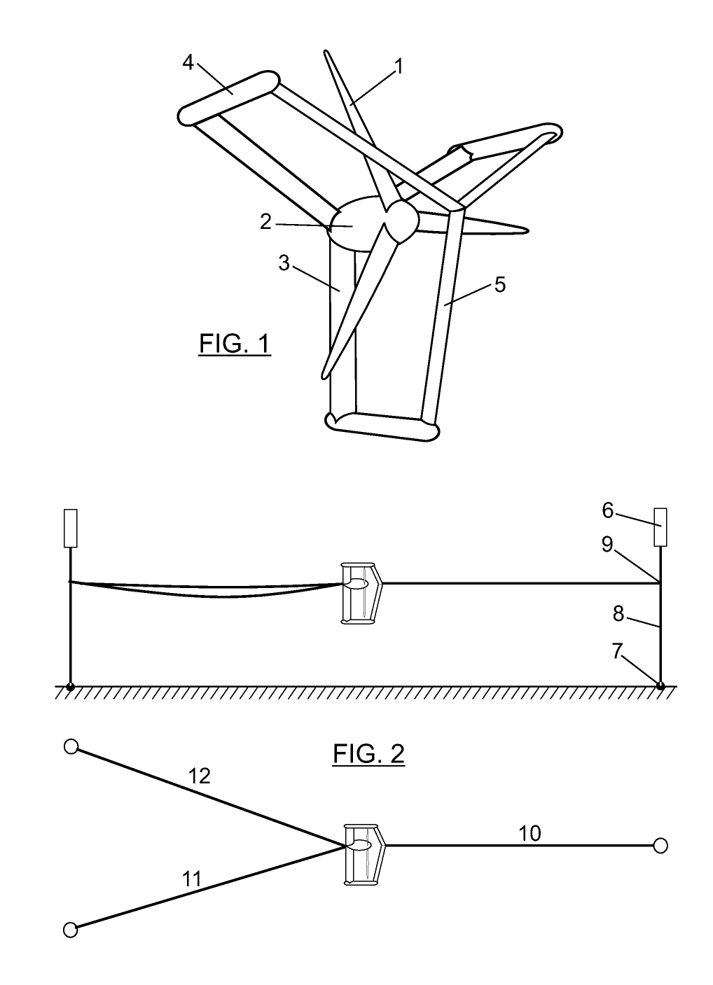

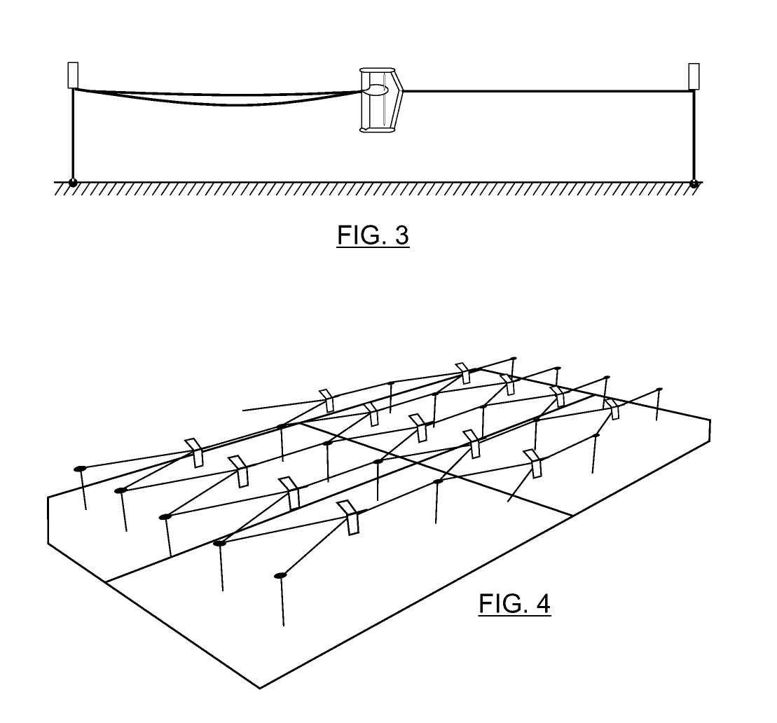

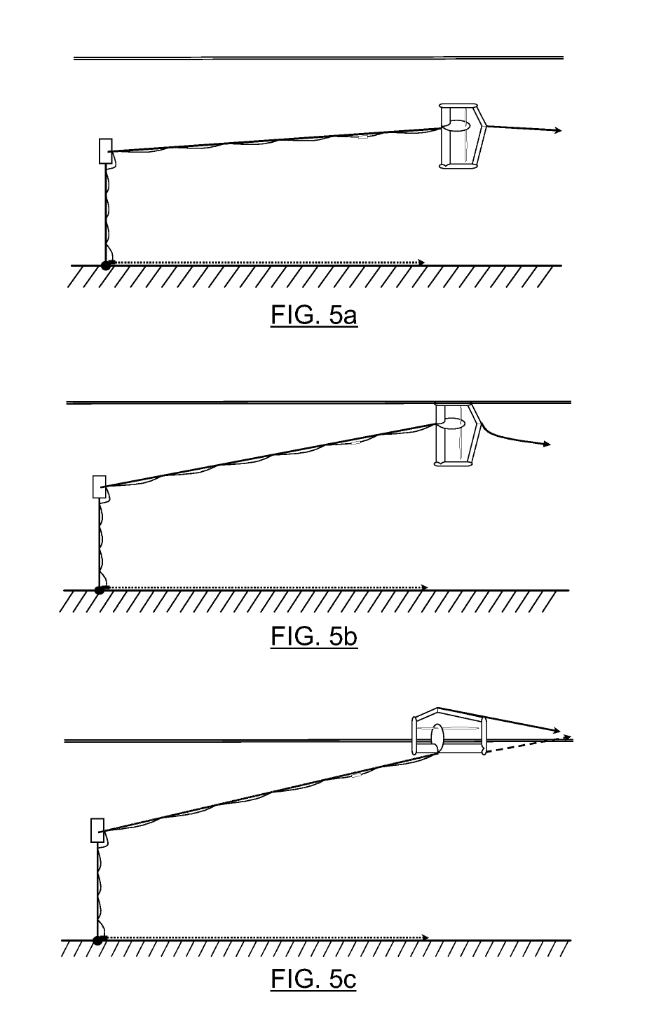

Therefore, the generator refloats, almost maintaining the vertical position (5.a), reaching the surface and slightly emerging therefrom (5b).

Once it is on the surface, the ballast tanks are emptied in an orderly fashion, so that the generator rotates and emerges, going from the vertical position to the horizontal one (5.c) more appropriate for maintenance and transportation.

For the system installation, once the anchoring system has been set in place, and with the generator floating on the surface, it shall be ballasted in reverse manner, so that it is vertical, and with the help of a guiding cable, which is joined to the end of the cable (10) and which goes through the coupling point of its anchoring line, this cable is connected to the remote control system.

### DISCLOSURE OF AT LEAST ONE EMBODIMENT OF THE INVENTION

The system described is formed by different elements used in the offshore, naval and eolic industry, which are coupled in a specific manner and which grant novel features. Specifically:

The rotor will be of a type similar to those of wind generators and the propellers of large craft, and they can be manufactured with composite materials (for example, carbon fibre) combined with metallic and/or hybrid materials.

The dome design shall be similar to that of POD propulsion systems (POD) for craft, integrating inside the electrical generator, coupled to the rotor (through a reducer or directly) with a waterproof horn and other elements such as the thrust block and the brake system.

The arms and torpedoes can be based on structures of tubular type (basically steel ones), similar to those used in offshore facilities surrounded by fairing which improve their hydrodynamic behaviour. The interior thereof shall house the ballast tanks. The tie beams will have a multi-profile structure, surrounded by fairing.

The ballast and unballast control will use blowing techniques, similar to those used in submarines, controlled by underwater remote control systems (by electrical optical cable and/or acoustic modem).

All the fixed elements (dome, arms and torpedoes) are joined by welding. The assembly of the AC generator, reducer and other power-related mechanical elements will be joined by a bed, wherein the assembly can be removed from the dome for its maintenance. The rotor blades will be joined to its core by means of bolts.

The anchoring system uses elements proven in the oil extraction platforms and aquaculture. The design of the remote control coupling system will be similar to that of fast slip hooks.

1. Underwater electrical energy generator for the harnessing of bidirectional marine currents wherein it comprises a rotor formed by a multi-blade propeller mounted on a central dome containing an electrical energy generator which is driven by the rotor and this assembly, formed by the rotor and the central dome, is supported by a radial structure, comprising a series of oval-shaped arms to reduce the resistance to the current flood serving as auxiliary ballast tanks and each one of these arms located in a plane perpendicular to the rotor axis end in a torpedo-shaped float which axis is parallel to that of the rotor, being closed at their free end by tie beams, which form a Y-shaped structure which assemblage point supports the connection of the anchoring cable, which by means of the horizontal tension pulling and together with the other cable which with the same alignment holds the rear part of the dome, enable to maintain the generator underwater and in the correct position to receive the current flood, when it moves in both directions, so that it goes through the rotor plane, in a manner perpendicular thereto and thus achieving the maximum harnessing of its energy.

2. The underwater electrical energy generator for the harnessing of marine currents according to claim 1, wherein it has ballast tanks arranged inside the arms and the floats, which, when filled or emptied, change the floatability and the centre of gravity of the whole structural assembly forming the generator and allow its positioning and also the surfacing and changing to the floating position when it is necessary to perform maintenance or removal tasks, the whole operational procedure being regulated by an automatic control system which includes a remote control by means of an assisting cable from which it is dropped by the slip hook of the anchoring system until it reaches the surface.

3. The underwater electrical energy generator for the harnessing of marine currents according to claim 1, wherein it has an anchoring system for its setting into the operation position comprising three anchoring lines, each one of which comprises the following elements, an anchoring point to the bottom, a vertical cable which starts at the previous point and ends in a buoy and which has the coupling point, located at the depth at which the rotor axis of the generator must operate and anchoring the structure comprising the generator, by means of its fixing to this anchoring system through three horizontal cables, the first one which joins the joining point of the tie beams with the anchoring point of one of the three anchoring lines forming a tie beam with the direction of the rotor axis and the other two and, joining the rear point of the dome with the other two anchoring lines, and each one of these two cables and forming a symmetrical horizontal line with respect to the rotor axis which is a bisecting line of the acute angle formed by the two cables.
